(19) United States
(12) Patent Application Publication
(10) Pub. No.: US 2026/0243959 A1
(43) Pub. Date: Aug. 20, 2026

(54) METHOD FOR PRODUCING OPTICAL COUPLING COMPONENT, AND OPTICAL COUPLING COMPONENT

(71) Applicants: SUMITOMO ELECTRIC INDUSTRIES, LTD., Osaka-shi, Osaka (JP); UTSUNOMIYA UNIVERSITY, Utsunomiya-shi, Tochigi (JP)

(72) Inventors: Shigehiro NAGANO, Osaka (JP); Manabu SHIOZAKI, Osaka (JP); Yoshio HAYASAKI, Tochigi (JP); Satoshi HASEGAWA, Tochigi (JP)

(73) Assignees: SUMITOMO ELECTRIC INDUSTRIES, LTD., Osaka-shi, Osaka (JP); UTSUNOMIYA UNIVERSITY, Utsunomiya-shi, Tochigi (JP)

(21) Appl. No.: 19/153,875

(22) PCT Filed: Feb. 7, 2024
(86) PCT No.: PCT/JP2024/004167

§ 371 Date: Aug. 5, 2025

(30) Foreign Application Priority Data
Feb. 22, 2023 (JP) 2023-026425

(51) Int. Cl. G02B 6/13; B23K 26/0622; B23K 26/064; B23K 26/073; B23K 26/53; B23K 103/00; G02B 6/12

(52) U.S. Cl. CPC G02B 6/13; B23K 26/0624; B23K 26/064; B23K 26/0736; B23K 26/53; B23K 2103/54; G02B 2006/12147

(57) ABSTRACT

A manufacturing method according to the present disclosure includes a preparation step, a laser irradiation step, and a condensed point movement step. Light intensity distribution of femtosecond laser light to be applied is identified by a coordinate axis with the laser light center as the origin, and the shape of the light intensity distribution is given in a range on the coordinate axis in which a beam diameter is −0.5 or more and +0.5 or less, and average light intensity AVO in a range on the coordinate axis of −0.1 or more and +0.1 or less is 70% or more and 99% or less of both average light intensity AV− in a range on the coordinate axis of −0.3 or more and −0.1 or less and average light intensity AV+ in a range on the coordinate axis of +0.1 or more and +0.3 or less.

### TECHNICAL FIELD

The present disclosure relates to a method for manufacturing an optical connection component, and an optical connection component. This application claims the priority of Japanese Patent Application No. 2023-026425 filed on Feb. 22, 2023, the contents of which are relied upon and incorporated herein by reference in their entirety.

### BACKGROUND ART

Optical connection components are generally used as optical signal transmitting/receiving components in optical communication. As a method for manufacturing such an optical connection component, for example, Non-Patent Literature 1 to Non-Patent Literature 5 disclose a technique for forming an optical waveguide by a writing method using a femtosecond laser light source. Specifically, Non-Patent Literature 1 discloses a technique for forming a core that is to become a waveguide by single-scan writing with femtosecond laser light. Non-Patent Literature 2 discloses a technique for forming a core having a square cross-sectional shape by multi-scan writing with femtosecond laser light. In addition, Non-Patent Literature 3 introduces a mechanism for increasing a refractive index (compression) by irradiation with femtosecond laser light, Non-Patent Literature 4 introduces a mechanism for increasing a refractive index (rearrangement of composition) by irradiation with femtosecond laser light, and Non-Patent Literature 5 introduces a mechanism for forming a nanograting periodic structure by irradiation with femtosecond laser light.

### CITATION LIST

### Non Patent Literature

Non Patent Literature 1: Dezhi Tan, et al., “Femtosecond laser writing low-loss waveguides in silica glass: highly symmetrical mode field and mechanism of refractive index change,” Optical Materials Express, Vol. 11, No. 3 pp. 848-857.

Non Patent Literature 2: Y. Nasu, et al., “Low-loss waveguides written with a femtosecond laser for flexible interconnection in a planar light-wave circuit”, Optics Letters, Vol. 30, pp. 723-725 (2005).

Non Patent Literature 3: E. N. Glezer and E. Mazur, “Ultrafast-laser driven micro-explosions in transparent materials,” Appl. Phys. Lett. Vol. 71, No. 7, pp. 882-884 (1997).

Non Patent Literature 4: Y. Liu, et al., “Micromodification of element distribution in glass using femtosecond laser irradiation,” OPTICS LETTERS, Vol. 34, No. 2, pp. 136-138 (2009).

Non Patent Literature 5: Y. Shimotsuma, et al., “Self-organized nanogratings in glass irradiated by ultrashort light pulses,” PHYSICAL REVIEW LETTERS, Vol. 91, No. 24, pp. 247405-1 to 247405-4 (2003).

Non Patent Literature 6: S. Masaaki, et al., “Improved phase hologram design for generating symmetric light spots and its application for laser writing of waveguides,” OPTICS LETTERS, Vol. 36, No. 7, Apr. 1, 2011, pp. 1065-1067.

Non Patent Literature 7: Keiji Fuse, “Beam Shaping for Advanced Laser Materials Processing,” Laser Technik Journal, pp. 19-22 (2015).

Non Patent Literature 8: S. Hasegawa, et al., “Holographic vector wave femtosecond laser processing,” International Journal of Optomechatronics, p. 73 (2014)

Non Patent Literature 9: Payne. F. P., et al., “A theoretical analysis of scattering loss from planar optical waveguides,” Optical and Quantum Electronics, vol. 26 (1994) pp. 977-986.

### SUMMARY OF INVENTION

A method for manufacturing an optical connection component according to the present disclosure includes a preparation step, a laser irradiation step, and a condensed point movement step. In the preparation step, a silica-based glass member is prepared. In the laser irradiation step, femtosecond laser light that has the amount of energy to cause a light-induced refractive index change in the glass member, is subjected to beam shaping, and has a pulse width of 500 fs or less is condensed and applied inside the glass member via a condenser lens. In the condensed point movement step, a condensed point position of the femtosecond laser light is relatively moved with respect to the glass member. Further, the laser irradiation step and the condensed point movement step are performed in conjunction with each other, so that a continuous refractive index change region functioning as an optical waveguide is formed inside the glass member. Light intensity distribution of the femtosecond laser light to be applied is identified by a coordinate axis passing through the center of gravity of a beam irradiation region of the femtosecond laser light at the condensed point position and extending along a direction orthogonal to the movement direction of the condensed point position with respect to the glass member, the coordinate axis having the center of the femtosecond laser light as the origin. The shape of the light intensity distribution satisfies the following three conditions. The first condition is that the beam diameter of the femtosecond laser light is given in a range on the coordinate axis of −0.5 or more and +0.5 or less. The second condition is that, in a range on the coordinate axis from −∞ to −0.1 and a range on the coordinate axis from +0.1 to +∞, the light intensity of the femtosecond laser light is increased as compared with the light intensity of a Gaussian beam with the same amount of laser light. The third condition is that average light intensity AV0 in a range on the coordinate axis of −0.1 or more and +0.1 or less is 70% or more and 99% or less of both average light intensity AV− in a range on the coordinate axis of −0.3 or more and −0.1 or less and average light intensity AV+ in a range on the coordinate axis of +0.1 or more and +0.3 or less.

### BRIEF DESCRIPTION OF DRAWINGS

FIG. 1 is a flowchart illustrating an example of a method for manufacturing an optical connection component according to the present disclosure.

FIG. 2 is a diagram illustrating an example of a configuration of a manufacturing apparatus for implementing the method for manufacturing an optical connection component according to the present disclosure, and illustrating laser light scanning.

FIG. 3 is a diagram illustrating various beam shaping optical systems and beam spot shapes.

FIG. 4 is a diagram illustrating a beam shape of a Gaussian beam used for forming an optical waveguide and a cross section of the formed optical waveguide.

FIG. 5 illustrates a relationship between a beam shape of laser light applied to the manufacturing method according to the present disclosure and a cross-sectional shape of an optical waveguide to be formed.

### DESCRIPTION OF EMBODIMENTS

### Solution to Problem

As a result of studying the above-described related art, the inventors have found the following problems. That is, the technique disclosed in Non-Patent Literature 1 has succeeded in forming an optical waveguide by the single-scan writing with femtosecond laser light, but the width of the optical waveguide is not controlled. Specifically, the shape of the obtained optical waveguide is long with respect to the laser irradiation axis, while the lateral direction of the optical waveguide is narrow, about 2 μm or less. This increases coupling loss of light propagating in the optical waveguide.

In contrast, the technique of Non-Patent Literature 2 has succeeded in forming an optical waveguide by multi-scan writing with femtosecond laser light. In the multi-scan writing, the width of the optical waveguide is controlled by scanning, 20 times, the femtosecond laser light emitted along the beam irradiation axis while shifting the femtosecond laser light in a direction orthogonal to the beam irradiation axis. However, the time required to form one optical waveguide is 20 times longer than that for single-scan writing. Non-Patent Literature 6 introduces a technique in which a plurality of branched beams, each of which is a diffracted light beam, is generated from femtosecond laser light using a hologram technology and the branched beams are applied to simultaneously form a plurality of optical waveguides inside a glass member. As described above, in the technique of Non-Patent Literature 6, since the optical waveguide is formed only by one scan, it is difficult to maintain a required width of the optical waveguide, which poses a problem that the productivity of optical connection components including optical waveguides is significantly reduced.

The present disclosure provides an optical connection component and a method for manufacturing an optical connection component that makes it easy to control a shape of an optical waveguide provided in the optical connection component and enables a significant increase in the productivity of the optical connection component.

### Advantageous Effects of Invention

According to the method for manufacturing an optical connection component of the present disclosure, the shape of the optical waveguide provided in an optical glass member can be easily controlled, and the productivity can be greatly increased.

### DESCRIPTION OF EMBODIMENTS OF PRESENT DISCLOSURE

First, contents of embodiments of the present disclosure are individually listed and described.
(1) A method for manufacturing an optical connection component according to the present disclosure includes: a preparation step, a laser irradiation step, and a condensed point movement step. In the preparation step, a silica-based glass member is prepared. In the laser irradiation step, femtosecond laser light that has the amount of energy to cause a light-induced refractive index change in the glass member, is subjected to beam shaping, and has a pulse width of 500 fs or less is condensed and applied inside the glass member via a condenser lens. In the condensed point movement step, a condensed point position of the femtosecond laser light is relatively moved with respect to the glass member. Further, the laser irradiation step and the condensed point movement step are performed in conjunction with each other, so that a continuous refractive index change region functioning as an optical waveguide is formed inside the glass member. Light intensity distribution of the femtosecond laser light to be applied is identified by a coordinate axis passing through the center of gravity of a beam irradiation region of the femtosecond laser light at the condensed point position and extending along a direction orthogonal to the movement direction of the condensed point position with respect to the glass member, the coordinate axis having the center of the femtosecond laser light as the origin. The shape of the light intensity distribution satisfies the following three conditions. The first condition is that the beam diameter of the femtosecond laser light is given in a range on the coordinate axis of −0.5 or more and +0.5 or less. The second condition is that, in a range on the coordinate axis from −∞ to −0.1 and a range on the coordinate axis from +0.1 to +∞, the light intensity of the femtosecond laser light is increased as compared with the light intensity of a Gaussian beam with the same amount of laser light. The third condition is that average light intensity AV0 in a range on the coordinate axis of −0.1 or more and +0.1 or less is 70% or more and 99% or less of both average light intensity AV− in a range on the coordinate axis of −0.3 or more and −0.1 or less and average light intensity AV+ in a range on the coordinate axis of +0.1 or more and +0.3 or less.

With this configuration, the shape of the optical waveguide provided in an optical glass member can be easily controlled, and the productivity can be greatly increased.
(2) In the above (1), in a range on the coordinate axis from −∞ to −0.1 and a range on the coordinate axis from +0.1 to +∞, the light intensity of the femtosecond laser light may be increased as compared with the light intensity of a Gaussian beam with the same amount of laser light. With this configuration, the shape of the optical waveguide provided in an optical glass member can be easily controlled, and the productivity can be greatly increased.
(3) In the above (1) or (2), the shape of the beam irradiation region at the condensed point position may have a first maximum width Zd along the movement direction and a second maximum width Yd along the direction orthogonal to the movement direction, and a ratio Yd/Zd of the second maximum width Yd to the first maximum width Zd may be 2 or more and 15 or less. This makes it easy to control the width of the optical waveguide formed in one scan.
(4) In any one of the above (1) to (3), an optical system used for the beam shaping may be any element selected from the group of an LCoS, a DOE, an aspheric lens, and a cylindrical lens, or a combination of a plurality of elements selected from the group. In this case, the shape of the beam irradiation region at the condensed point position can be formed into any shape.
(5) In any one of the above (1) to (4), the shape of the refractive index change region may be a quadrangle in a plane orthogonal to the movement direction of the condensed point position with respect to the glass member. This makes the light intensity distribution of a propagation mode a perfect circle, which improves the coupling efficiency with a single mode fiber (SMF).
(6) An optical connection component according to the present disclosure is an optical connection component manufactured by any one of the manufacturing methods described in (1) to (5) above, and the shape of the refractive index change region may be a quadrangle in a plane orthogonal to the movement direction of the condensed point position with respect to the glass member.
(7) In the above (6), the refractive index inside the quadrangle may be uniform. This can reduce the propagation loss.

Each aspect listed in the section of [Description of Embodiments of Present Disclosure] above is applicable to each of all the remaining aspects or to all combinations of these remaining aspects.

### Details of Embodiments of Present Disclosure

Hereinafter, a specific structure of a method for manufacturing an optical connection component and an optical connection component according to the present disclosure will be described in detail with reference to the accompanying drawings. Note that the present disclosure is not limited to these examples, indicated by the claims, and intended to include all modifications within the meaning and scope equivalent to the claims. In the description of the drawings, the same elements are denoted by the same reference numerals, and redundant description is omitted.

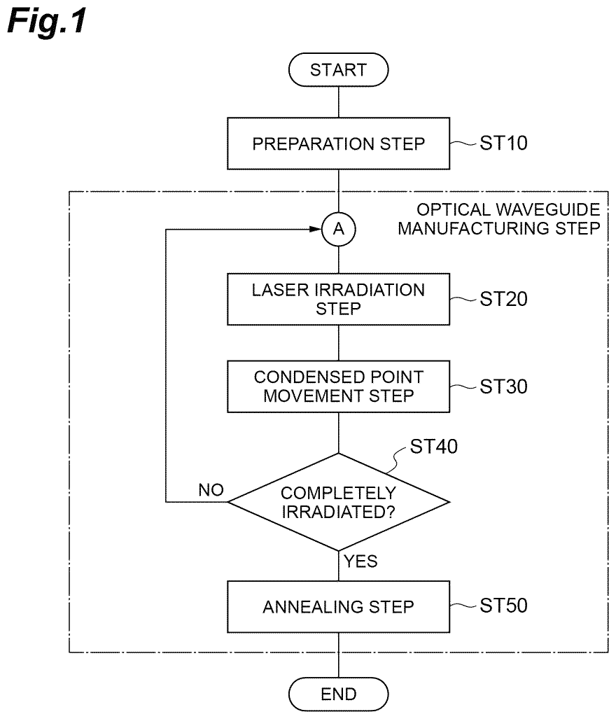

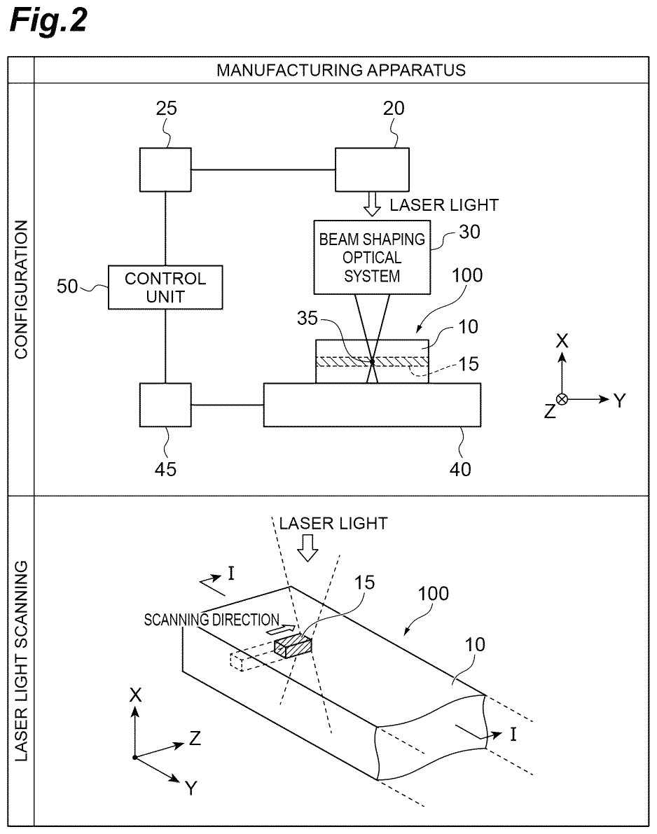

FIG. 1 is a flowchart illustrating an example of a method for manufacturing an optical connection component 100 according to the present disclosure. FIG. 2 is a diagram illustrating an example of a configuration of a manufacturing apparatus for implementing the method for manufacturing an optical connection component 100 according to the present disclosure, and illustrating laser light scanning (in FIG. 2, labeled “manufacturing apparatus”). The upper part of FIG. 2 (in FIG. 2, labeled “configuration”) illustrates a configuration example of the manufacturing apparatus. The lower part of FIG. 2 (in FIG. 2, labeled “laser light scanning”) illustrates laser light scanning in the laser irradiation step.

The manufacturing apparatus illustrated in the upper part of FIG. 2 includes a femtosecond laser 20, a laser drive unit 25 for driving the femtosecond laser 20, a beam shaping optical system 30 for shaping a beam spot of femtosecond laser light into any shape, an XYZ stage 40, a stage drive unit 45 for driving the XYZ stage 40, and a control unit 50 for controlling operations of the individual portions.

The laser drive unit 25 controls the power and the repetition frequency of pulsed laser light (hereinafter, referred to as “femtosecond laser light”) to be outputted from the femtosecond laser 20 in accordance with an instruction from the control unit 50. This allows the femtosecond laser 20 to output femtosecond laser light having a pulse width of several hundred femtoseconds or less. In particular, the femtosecond laser light having a pulse width set to several hundred femtoseconds or less can have a peak power of 10⁵ W/cm² or more. The repetition frequency of the femtosecond laser light to be outputted may be 10 kHz or more in order to smooth the refractive index and structure of the optical waveguide formed inside the glass material. A glass member 10 to be a body of the optical component is placed on a device mounting surface of the XYZ stage 40. The glass member 10 is glass capable of causing a pressure-induced refractive index change Δnp, and both Δnp and a structure-induced refractive index change Δnd by laser irradiation, for example, silica-based glass. The silica-based glass is mainly composed of silicon dioxide (SiO₂) and contains 50% or more of SiO₂. Glass not doped with impurities, germanium (Ge) doped glass, glass co-doped with Ge and boron (B), or the like may be used. More specifically, glass containing no dopant other than Ge, or glass co-doped with B and Ge may be used. Alternatively, the glass may be quartz-based glass, phosphate-based glass, halide glass, and sulfide glass. The femtosecond laser light outputted from the femtosecond laser 20 is condensed by the beam shaping optical system 30 within the glass member 10 placed on the XYZ stage 40, that is, at a condensed point 35 located on the YZ plane. As a result, a refractive index change region 15 is formed as an optical waveguide inside the glass member 10, and the optical connection component 100 is achieved. An axis along a scanning direction of the laser light is set to the Z axis. An axis perpendicular to the Z axis and perpendicular to a laser irradiation surface of the glass member 10 is set to the X axis. An axis perpendicular to the scanning direction and perpendicular to both the Z axis and the X axis is set to the Y axis.

In accordance with an instruction from the control unit 50, the stage drive unit 45 drives the XYZ stage 40 so that the device mounting surface of the XYZ stage 40 moves along each of the X-axis direction, the Y-axis direction, and the Z-axis direction. This configuration enables laser scanning as illustrated in the lower part of FIG. 2, and the position of the condensed point 35 of the femtosecond laser light moves relatively with respect to the glass member 10. The control unit 50 controls each operation of the laser drive unit 25 and the stage drive unit 45 as described above, so that the refractive index change region 15 having any pattern is formed inside the glass member 10. Incidentally, that any pattern matches the shape of the optical waveguide projected onto the YZ plane in consideration of the depth direction information of the X axis. Through the above steps, the optical connection component 100 as an optical component is manufactured.

Next, the manufacturing apparatus having the above-described structure is used to manufacture the optical connection component 100 provided with the optical waveguide. A method for manufacturing the optical connection component 100 according to the present disclosure will be described with reference to the flowchart of FIG. 1. In the following description, as an example of the method for manufacturing the optical connection component 100, a case of manufacturing a three-dimensional optical waveguide device in which the refractive index change region 15 of any pattern to become an optical waveguide is formed will be described.

The method for manufacturing the optical connection component 100 according to the present disclosure includes a preparation step and an optical waveguide manufacturing step. First, in the preparation step, as a glass member 10 which is to become the optical connection component 100, for example, parallel plate glass is prepared (Step ST10).

In the optical waveguide manufacturing step, the refractive index change region 15 of any pattern, which is to become an optical waveguide, is formed inside the prepared glass member 10. Specifically, the prepared glass member 10 is placed on the device mounting surface of the XYZ stage 40 immediately after the completion of Step ST10, and is irradiated with femtosecond laser light (Step ST20). The control unit 50 controls the laser drive unit 25 such that the femtosecond laser 20 outputs the femtosecond laser light having the amount of energy to cause a light-induced refractive index change inside the glass member 10 and having a repetition frequency of 10 kHz or more. The femtosecond laser light outputted from the femtosecond laser 20 is condensed inside the glass member 10 by the beam shaping optical system 30. The beam shaping optical system 30 shapes the beam spot of the input femtosecond laser light into a predetermined shape. A light-induced refractive index change is formed in the beam irradiation region at the condensed point 35 of the femtosecond laser light. When the laser irradiation to a predetermined portion of the glass member 10 is completed, the control unit 50 controls the stage drive unit 45 to move the position of the glass member 10 placed on the device mounting surface of the XYZ stage 40 (Step ST30). As described above, in a condensed point movement step (Step ST30), as illustrated in the lower part of FIG. 2, the position of the condensed point 35 of the femtosecond laser light inside the glass member 10 is moved by continuously or intermittently changing the setting position of the glass member 10, the position of the condensed point 35 of the femtosecond laser light, or both the setting position and the condensed point position.

The laser irradiation step in Step ST20 and the condensed point movement step in Step ST30, specifically, the operation control on the laser drive unit 25 and the stage drive unit 45 by the control unit 50 is repeatedly performed while changing the irradiation conditions or under the same conditions, returning to the point indicated by point C in FIG. 1 until a pre-designed optical waveguide pattern is formed inside the glass member 10 (Step ST40). When the refractive index change region 15 is completely formed inside the glass member 10 (Step ST40), the glass member 10 is annealed for aging treatment or the like so that the refractive index does not change over a long period of time (Step ST50). Through the above steps, an optical connection component with an optical waveguide provided therein is acquired.

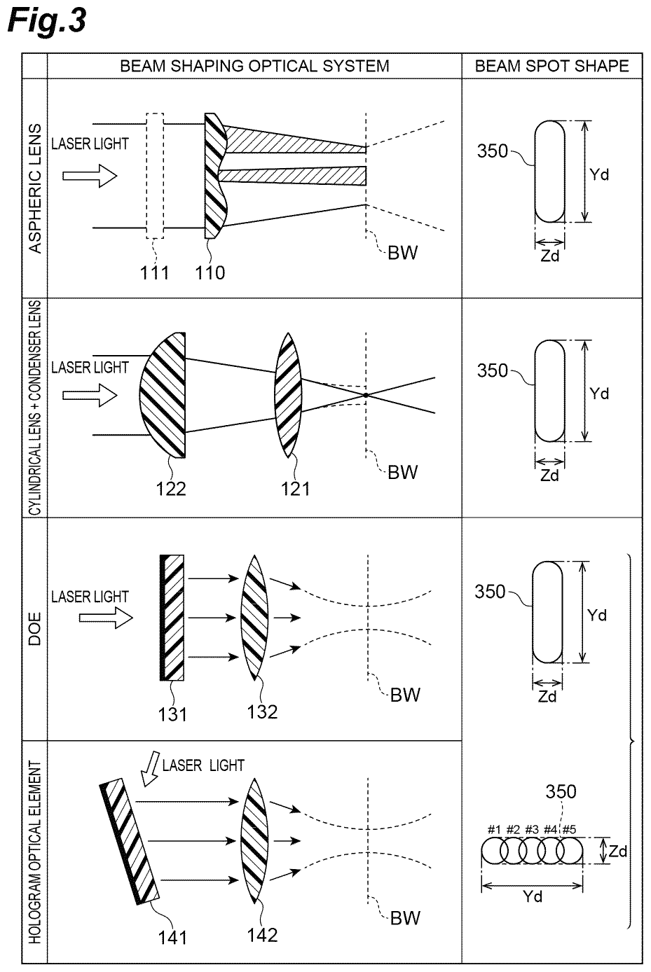

Examples of the beam shaping optical system 30 include an optical system having an aspheric lens, an optical system in which a condenser lens and a cylindrical lens are combined, and a DOE (diffractive optical element) as illustrated in FIG. 3. The DOE includes LCoS (liquid crystal on silicon). Here, a glass type in which the refractive index modulation is non-variable is referred to as DOE, and an LCoS in which the refractive index modulation is variable is referred to as a hologram optical element. The top row of FIG. 3 (in FIG. 3, labeled “aspheric lens”) illustrates a configuration of an optical system including an aspheric lens 110. The second row of FIG. 3 (in FIG. 3, labeled “cylindrical lens+condenser lens”) illustrates a configuration of an optical system in which a cylindrical lens and a condenser lens are combined. The third row of FIG. 3 (in FIG. 3, labeled “DOE”) illustrates a configuration of an optical system including a DOE. The bottom row of FIG. 3 (in FIG. 3, labeled “hologram optical element”) illustrates a configuration of an optical system including a hologram optical element.

A first optical system using an aspheric lens illustrated in the top row of FIG. 3 includes the aspheric lens 110. Note that a beam shaper 111 may be provided upstream or downstream of the aspheric lens 110 as necessary. The total light intensity distribution (hereinafter, simply referred to as “light intensity distribution”) of the femtosecond laser light output from the aspheric lens 110 is defined on a beam waist BW where the condensed point 35 is located and which is included in the YZ plane. The beam spot of the femtosecond laser light corresponds to a beam irradiation region 350 having a first maximum width of Zd along the Z-axis direction and a second maximum width of Yd (≥Zd) along the Y-axis direction.

A second optical system configured with a condenser lens and a cylindrical lens illustrated in the second row of FIG. 3 includes a condenser lens 121 and a cylindrical lens 122, and outputs femtosecond laser light having a beam spot corresponding to a beam irradiation region 350 having a width of Yd along the Y-axis direction and a width of Zd (≤Yd) along the Z-axis direction, similarly to the “aspheric lens” optical system described above.

A third optical system configured with a condenser lens and a DOE illustrated in the third row of FIG. 3 includes a DOE 131 and a condenser lens 132. The DOE 131 receives femtosecond laser light from the femtosecond laser 20 and outputs a branched beam group of various beam arrangement patterns. The condenser lens 132 focuses the plurality of branched beams output from the DOE 131 inside the glass member 10 with the beam arrangement pattern maintained. A fourth optical system configured with a condenser lens and a hologram optical element illustrated in the bottom row of FIG. 3 includes an LCoS 141 that is a hologram optical element and a condenser lens 142. The LCoS 141 receives femtosecond laser light from the femtosecond laser 20 and outputs a branched beam group of various beam arrangement patterns. The condenser lens 142 focuses the plurality of branched beams output from the LCoS 141 inside the glass member 10 with the beam arrangement pattern maintained. For example, in a case where five branched beams are output from the DOE 131 or the LCoS 141, beam spots #1 to #5 of the branched beams may be spatially separated such that the spot centers are arranged along the Y-axis direction as illustrated on the right side of the third and bottom rows in FIG. 3. In this case, the beam spots #1 to #5 form the beam irradiation region 350.

As described above, it is known that a refractive index change region that is to become an optical waveguide is formed inside a glass member by a writing method using a femtosecond laser light source (Non-Patent Literatures 3 and 4). In addition, it has also been proposed to improve the productivity by splitting femtosecond laser light into a plurality of diffracted light using a hologram diffraction element or the like and simultaneously forming a plurality of optical waveguides by each of a plurality of branched beams constituted by the diffracted light (Non-Patent Literature 6).

In contrast, in the embodiment of the present disclosure, the beam irradiation region 350 is defined on the beam waist BW included in the YZ plane where the condensed point 35 is present. In the beam irradiation region 350, the light-collecting power in the Z-axis direction is set to the diffraction limit or the vicinity thereof. On the other hand, the light-collecting power in the Y-axis direction is set to be weaker than the light-collecting power in the Z-axis direction. For example, assuming that the beam diameter in the Z-axis direction is 1, the beam diameter in the Y-axis is 2 or more and 15 or less, that is, the ratio Yd/Zd is 2 or more and 15 or less. The beam diameter defined along the Y-axis direction on the beam waist BW, that is, the beam width, is a distance between positions where the light intensity is 1/e² of the maximum light intensity, on either side of the beam center.

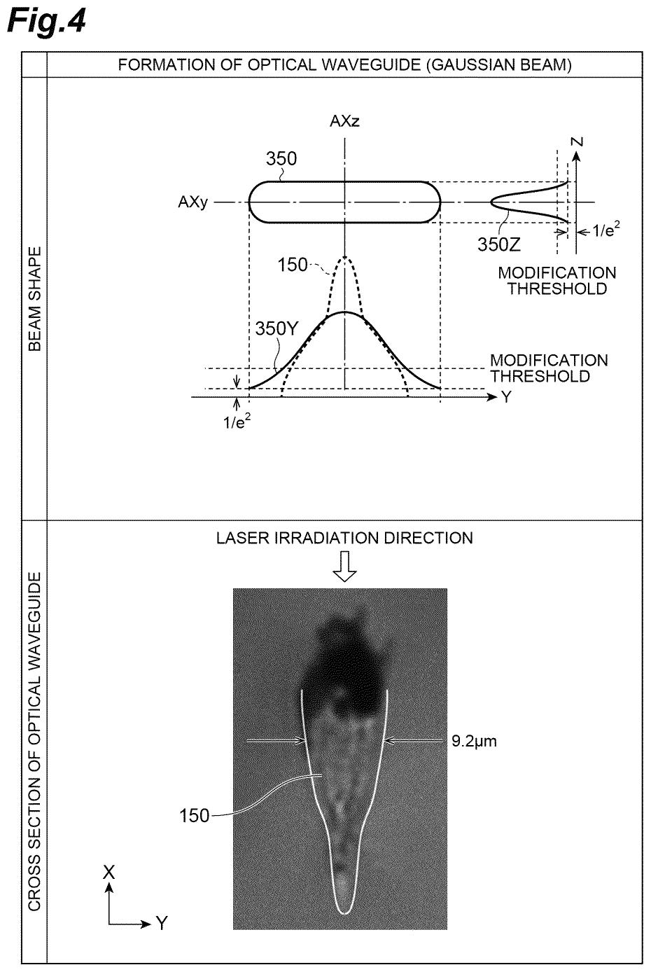

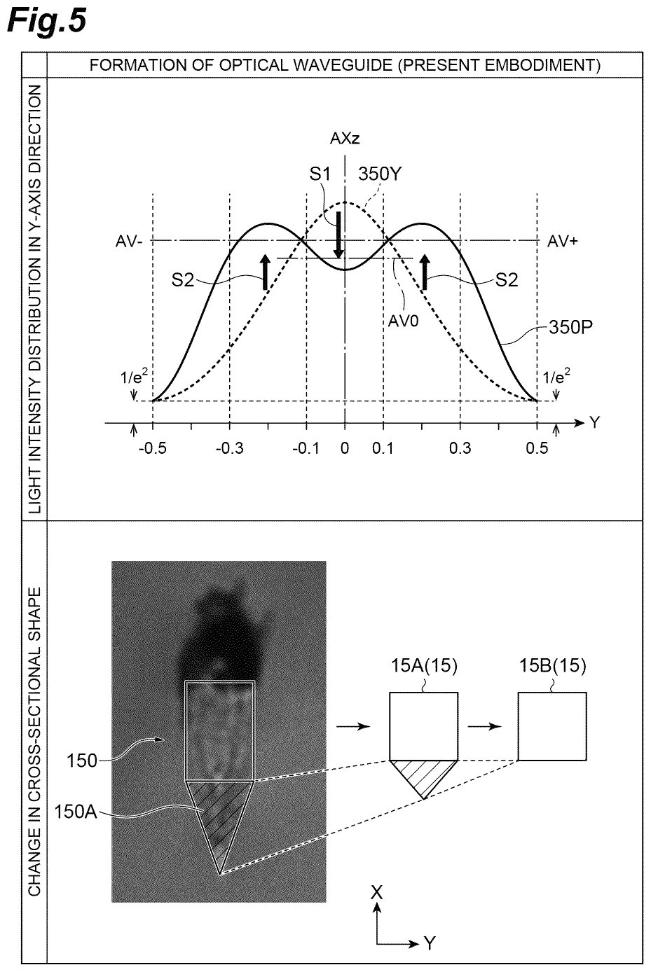

Specifically, the femtosecond laser light is condensed inside the glass member 10 by the beam shaping optical system 30 illustrated in FIG. 3, and the refractive index change region 15 is formed inside the glass member 10 by driving the XYZ stage 40. The wavelength of the laser light is, for example, in a range of −10 nm or more and +10 nm or less with reference to 1030 nm, a range of −10 nm or more and +10 nm or less with reference to 1060 nm, second harmonic generation (SHG) in each wavelength range, or third harmonic generation (THG) in each wavelength range. The pulse width of the laser light is 500 fs or less. The repetition frequency is 100 kHz or more and 5 MHz or less. Hereinafter, FIG. 4 illustrates an example of Gaussian beam irradiation as a comparative example, while FIG. 5 illustrates an example of an embodiment of the present disclosure.

FIG. 4 is a diagram illustrating a beam shape of a Gaussian beam used for forming an optical waveguide and a cross section of the formed optical waveguide (in FIG. 5, labeled “formation of optical waveguide (Gaussian beam)”. The upper part of FIG. 4 (in FIG. 4, labeled “beam shape”) illustrates a beam irradiation region 350 of the Gaussian beam defined on the YZ plane, light intensity distribution 350Y along the central axis of the beam irradiation region 350 parallel to the Y axis, and light intensity distribution 350Z along the central axis of the beam irradiation region 350 parallel to the Z axis. The lower part of FIG. 4 (in FIG. 4, labeled “cross section of optical waveguide”) illustrates a cross section of the optical waveguide taken along the I-I line illustrated in the lower part of FIG. 2 and formed by irradiation with a beam having the light intensity distribution illustrated in the upper part of FIG. 4.

As illustrated in the upper part of FIG. 4, the beam irradiation region 350 defined on the beam waist BW is beam-shaped by the beam shaping optical system 30 illustrated in FIG. 3. That is, the femtosecond laser light applied to the inside of the glass member 10 is a Gaussian beam with a beam diameter along the Z-axis direction set to about 1 μm or less and a beam diameter along the Y-axis direction set to 2 μm or more and 10 μm or less. The Gaussian beam itself has the light intensity distribution 350Y along the Y-axis direction and the light intensity distribution 350Z along the Z-axis direction. The light intensity distribution 350Y is light intensity distribution centered on an axis AXz parallel to the Z axis among two axes orthogonal to each other at the center of gravity of the beam irradiation region 350, and the light intensity distribution 350Z is light intensity distribution centered on an axis AXy parallel to the Y axis. The Gaussian beam is applied, so that a refractive index change region 150 having a cross-sectional shape illustrated in the lower part of FIG. 4 is obtained. The refractive index change region 150 functions as an optical waveguide. In the example illustrated in the lower part of FIG. 4, the NA of the condenser lens used in the beam shaping optical system 30 is 0.40 or more and 0.55 or less. The wavelength of the incident beam is 1030 nm, or 515 nm for its SHG. The pulse width is 100 fs or more and 450 fs or less. The scanning speed is 0.01 mm/sec or more and 10 mm/sec or less. The pulse energy is 30 nJ or more and 1000 nJ or less. The repetition frequency is 100 kHz or more and 5 MHz or less. The position of the condensed point 35 was set to a depth of 50 μm or more and 250 μm or less of the glass member 10 from the surface of the glass member 10.

As can be seen from the cross-sectional shape of the refractive index change region 150 illustrated in the lower part of FIG. 4, an optical waveguide width of 9.2 μm was obtained in one beam scanning. It has been found that the optical waveguide width can be controlled to 3 μm or more and 10 μm or less by adjusting the laser light power. In the light intensity distribution 350Y in the Y-axis direction illustrated in the upper part of FIG. 4, for reference, the outline of the refractive index change region 150 formed by irradiation with the Gaussian beam is indicated by a broken line. That is, the outline of the refractive index change region 150 is superimposed on the light intensity distribution 350Y in the Y-axis direction to match the scale. As a result, it has been found that there is a modification threshold at which a modified region to become the refractive index change region 150 is formed inside the glass member 10, and the cross-sectional shape of the refractive index change region 150 is substantially consistent with the shape of the light intensity distribution 350Y except for the central portion extending along the X-axis direction. On the other hand, the cross-sectional shape of the refractive index change region 150 illustrated in the lower part of FIG. 4 is a shape elongated in the X-axis direction. Therefore, a high-order mode is generated in the X-axis direction, and it cannot be used for an optical waveguide for single mode propagation. It is thus necessary to set appropriate laser light intensity based on the modified shape.

Further, as described above, the central portion of the refractive index change region 150 has a shape that is more modified than the shape of the light intensity distribution 350Y. In particular, as described in Non-Patent Literature 3 and Non-Patent Literature 4, it is known that, on the side irradiated with the laser light, electrons excited due to multiphoton absorption further increase excited electrons from nonlinear absorption. As described above, it is presumed that the absorption of the irradiated laser light causes the region having high light intensity distribution in the central region to be further modified.

In a case where the inside of the glass member 10 is irradiated with the laser beam under the above-described conditions, an irradiation side modified region, different from the refractive index change region 150, is generated on the side irradiated with the laser light. It is known that a nanograting of about several hundred nm is formed in the irradiation side modified region, and further, the nanograting is formed perpendicular to the polarization of the applied laser light (Non-Patent Literature 5). Non-Patent Literature 7 discloses a beam shaping technique, and Non-Patent Literature 8 indicates that a nanograting is formed depending on polarization of a plurality of multi-branched beams. Therefore, the refractive index change region 150 is used as an optical waveguide, and the irradiation side modified region located on the irradiation side of the laser light can be regarded as an optical cladding, and there is a problem that the propagation loss is increased due to a nanograting having a periodic refractive index fluctuation of the optical cladding. Note that a relationship of a propagation loss related to periods having different refractive indexes is disclosed in Non-Patent Literature 9.

FIG. 5 illustrates a relationship between a beam shape of laser light applied to the manufacturing method according to the present disclosure and a cross-sectional shape of an optical waveguide to be formed (in FIG. 5, labeled “formation of optical waveguide (present embodiment)”). The upper part of FIG. 5 (in FIG. 5, labeled “light intensity distribution in Y-axis direction”) illustrates light intensity distribution 350P of laser light applied to the method for manufacturing an optical waveguide according to the present disclosure, as light intensity distribution corresponding to the light intensity distribution 350Y illustrated in the upper part of FIG. 4. The lower part of FIG. 5 (in FIG. 5, labeled “cross section of optical waveguide”) illustrates a cross section of the optical waveguide taken along the I-I line illustrated in the lower part of FIG. 2 and formed by irradiation with a beam having the light intensity distribution illustrated in the upper part of FIG. 5.

As illustrated in the upper part of FIG. 4, the shape of the refractive index change region 150 formed by irradiation with laser light is consistent with the shape of the light intensity distribution 350Y in the Y-axis direction except for the central portion. This means that the cross-sectional shape of the refractive index change region 15 formed inside the glass member 10 by irradiation with laser light can be controlled to a desired shape by adjusting the shape of the intensity distribution of the femtosecond laser light to be applied.

In the embodiment of the present disclosure, the femtosecond laser light applied to the glass member 10 has the light intensity distribution 350P in the Y-axis direction as illustrated in the upper part of FIG. 5. The light intensity distribution 350P of the femtosecond laser light is defined by a coordinate axis passing through the center of gravity of the beam irradiation region 350 of the femtosecond laser light at the position of the condensed point 35 and extending along the Y-axis direction orthogonal to the scanning direction, the coordinate axis having the position of the axis AXz indicating the center of the femtosecond laser light as the origin. On the coordinate axis along the Y axis, the beam diameter of the femtosecond laser light is given in a range of −0.5 or more and +0.5 or less. That is, the beam width at the position where the beam has light intensity of 1/e² of the maximum light intensity is set to 1. With reference to the light intensity distribution 350Y of the Gaussian beam in the Y-axis direction indicated by the broken line, the light intensity distribution 350P expands in the direction indicated by the arrow S2 in the range from −∞ to −0.1, is concave in the direction indicated by the arrow S1 in the range of −0.1 or more and +0.1 or less, and expands in the direction indicated by the arrow S2 in the range from +0.1 to +∞.

As a more specific range, in the light intensity distribution 350P, in the range from −∞ to −0.1 and the range from +0.1 to +∞, the light intensity of the femtosecond laser light is increased as compared with the light intensity of a Gaussian beam with the same amount of laser light. In addition, the average light intensity AV0 in the range of −0.1 or more and +0.1 or less may be 70% or more and 99% or less of both the average light intensity AV− in the range of −0.3 or more and −0.1 or less and the average light intensity AV+ in the range of +0.1 or more and +0.3 or less.

By setting the light intensity distribution 350P of the femtosecond laser to be applied within the above-described range, the cross-sectional shape of the refractive index change region 15 formed inside the glass member 10 can be made, among the cross-sectional shapes illustrated in the lower part of FIG. 5, closer to the cross-sectional shape of a refractive index change region 15B illustrated on the right side from the shape of the refractive index change region 150 illustrated on the left side. That is, a shaded region 150A extending along the X-axis direction is formed in the refractive index change region 150 illustrated on the left side. This causes the generation of a high-order mode in the X-axis direction. On the other hand, in a case where the average light intensity AV0 in the range of −0.1 or more and +0.1 or less is set to 99% or less of both the average light intensity AV− in the range of −0.3 or more and −0.1 or less and the average light intensity AV+ in the range of +0.1 or more and +0.3 or less, a part corresponding to the shaded region 150A of the refractive index change region 150 on the left side can be reduced, as in a refractive index change region 15A illustrated in the lower part and the center of FIG. 5. Further, in a case where the average light intensity AV0 is lower than both the average light intensity AV− and AV+, it is also possible to reduce the formation itself of the part corresponding to the shaded region 150A of the refractive index change region 150 on the left side, as in the refractive index change region 15B illustrated in the lower part and the right side of FIG. 5. That is, an optical waveguide in which the cross-sectional shape of the refractive index change region 15 is a quadrangle can be manufactured. This makes the light intensity distribution of the propagation mode a perfect circle, which improves the coupling efficiency with the SMF. In addition, since the width required for the cross-sectional shape of the refractive index change region 15 can be maintained, the productivity of the optical waveguide can be increased. In the multi-scan writing method, when the core is scanned in the lateral direction, the etching shape reflecting the modified layer inside the core has a comb tooth shape parallel to the beam irradiation axis direction. In the etching shape inside the core of the present method, no comb tooth shape appears, a boundary between the presence or absence of modification appears, and the inside is etched with a uniform refractive index. This can reduce the propagation loss.

### REFERENCE SIGNS LIST

10 GLASS MEMBER
15, 15A, 15B REFRACTIVE INDEX CHANGE REGION
20 FEMTOSECOND LASER
25 LASER DRIVE UNIT
30 BEAM SHAPING OPTICAL SYSTEM
35 CONDENSED POINT
40 XYZ STAGE
45 STAGE DRIVE UNIT
50 CONTROL UNIT
100 OPTICAL CONNECTION COMPONENT
110 ASPHERIC LENS
111 BEAM SHAPER
121 CONDENSER LENS
122 CYLINDRICAL LENS
131 DOE
132 CONDENSER LENS
141 LCoS
142 CONDENSER LENS
350 BEAM IRRADIATION REGION
350Y, 350Z, 350P LIGHT INTENSITY DISTRIBUTION
#1 TO #5 BEAM SPOT
BW BEAM WAIST

1. A method for manufacturing an optical connection component comprising:
a preparation step of preparing a silica-based glass member;
a laser irradiation step of condensing and applying femtosecond laser light into the glass member via a condenser lens, the femtosecond laser light having an amount of energy to cause a light-induced refractive index change in the glass member, being subjected to beam shaping, and having a pulse width of 500 fs or less; and
a condensed point movement step of relatively moving a condensed point position of the femtosecond laser light with respect to the glass member,
wherein the laser irradiation step and the condensed point movement step are performed in conjunction with each other to form a continuous refractive index change region inside the glass member,
wherein light intensity distribution of the femtosecond laser light is identified by a coordinate axis passing through a center of gravity of a beam irradiation region of the femtosecond laser light at the condensed point position and extending along a direction orthogonal to a movement direction of the condensed point position with respect to the glass member, the coordinate axis having a center of the femtosecond laser light as an origin,
wherein a shape of the light intensity distribution is given in a range on the coordinate axis in which a beam diameter of the femtosecond laser light is −0.5 or more and +0.5 or less, and
wherein average light intensity AV0 in a range on the coordinate axis of −0.1 or more and +0.1 or less is 70% or more and 99% or less of both average light intensity AV− in a range on the coordinate axis of −0.3 or more and −0.1 or less and average light intensity AV+ in a range on the coordinate axis of +0.1 or more and +0.3 or less.

2. The method for manufacturing an optical connection component according to claim 1,
wherein in a range on the coordinate axis from −∞ to −0.1 and a range on the coordinate axis from +0.1 to +∞, light intensity of the femtosecond laser light is increased as compared with light intensity of a Gaussian beam with a same amount of laser light.

3. The method for manufacturing an optical connection component according to claim 1,
wherein a shape of the beam irradiation region at the condensed point position
has a first maximum width Zd along the movement direction,
has a second maximum width Yd along a direction orthogonal to the movement direction, and
a ratio Yd/Zd of the second maximum width Yd to the first maximum width Zd is 2 or more and 15 or less.

4. The method for manufacturing an optical connection component according to claim 1,
wherein an optical system used for the beam shaping includes at least one of a DOE, an aspheric lens, and a cylindrical lens.

5. The method for manufacturing an optical connection component according to claim 1,
wherein a shape of the refractive index change region is a quadrangle in a plane orthogonal to the movement direction of the condensed point position with respect to the glass member.

6. An optical connection component
manufactured by the method for manufacturing an optical connection component according to claim 1,
wherein a shape of the refractive index change region is a quadrangle in a plane orthogonal to the movement direction of the condensed point position with respect to the glass member.

7. The optical connection component according to claim 6,
wherein a refractive index inside the quadrangle is uniform.
